(19) United States
(12) Patent Application Publication
(10) Pub. No.: US 2012/0130821 A1
(43) Pub. Date: May 24, 2012

(54) POINT-OF-SALE PURCHASE PERSONALIZED MESSAGE

(75) Inventors: ERIC FRANKEL, LOS ANGELES, CA (US); ARIEL JALALI, LOS ANGELES, CA (US); MARK E. CHODOS, TEMPLE CITY, CA (US)

(73) Assignee: StarGreetz, Inc., Los Angeles, CA (US)

(21) Appl. No.: 13/240,845

(22) Filed: Sep. 22, 2011

Related U.S. Application Data
(60) Provisional application No. 61/385,458, filed on Sep. 22, 2010.

(51) Int. Cl. G06Q 30/02

(52) U.S. Cl. 705/14.67

(57) ABSTRACT

A method, apparatus, system, article of manufacture, and computer program product provide a personalized promotional message. A request is received for the message. The request includes a keyword that denotes personalized attributes and a token that denotes a name of a consumer and is a component position in a script product. Based on the request, media components are concatenated to produce the personalized promotional message that is transmitted and received by the consumer.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 61/385,458, filed on Sep. 22, 2010, by Eric Frankel, Ariel Jalali, and Scott LaRocca, entitled “Point-of-Sale Purchase Personalized Message,” attorneys' docket number 248.4-US-P1.

### BACKGROUND OF THE INVENTION

1. Field of the Invention

The present invention relates generally to advertising, and in particular, to a method, system, apparatus, computer program product, and article of manufacture for delivering personalized advertisements to individuals.

2. Description of the Related Art

Retailers, brands, manufacturers, service providers and other resellers extensively use site-based advertising and displays (e.g., static print and electronic signage, billboards, bus-siding, bench backs, etc.) to attract the attention of potential buyers/customers. Billions of dollars are spent annually on such advertising.

There are currently little-to-no methods by which to address such advertising to individuals in public places. Embodiments of the present invention establish a method for advertisers to send messages about their products addressed personally to individuals who want to receive such information.

### SUMMARY OF THE INVENTION

To overcome the problems of the prior art, embodiments of the invention utilize a call-to-action that offers a consumer a personalized advertiser/promotional message in response to the user sending an email/text to a designated location (e.g., email or phone number). The email/text requested in the call-to-action contains certain information (e.g., an alphanumeric code and the user's name).

In response to receipt of the email/text from the user, the email is parsed and provided to an application capable of creating a single digital file that consists of a concatenation of various media components. The single digital file is a personalized promotional/advertising message that is personalized based on the information in the email/text (e.g., contains the user's name and/or information relating to the location of where the user is located [e.g., proximate to the call-to-action]). The personalized message (which may be audio or audio-video) is then dynamically transmitted/delivered back to the user (e.g., to the user's cellular device) for listening/viewing.

### BRIEF DESCRIPTION OF THE DRAWINGS

Referring now to the drawings in which like reference numbers represent corresponding parts throughout:

FIG. 1 illustrates an exemplary network configuration that could be used to provide inter-network communications;

FIG. 2 is an exemplary hardware and software environment used to implement one or more embodiments of the invention;

FIG. 3 is a data flow diagram utilized to personalize advertising to a user in accordance with one or more embodiments of the invention;

FIG. 4 illustrates an exemplary call-to-action in accordance with one or more embodiments of the invention;

FIG. 5 illustrates a portion of the database schema used to store media components and concatenated clips in a database in accordance with one or more embodiments of the invention; and

FIG. 6 illustrates the logical flow for creating and delivering a point-of-sale personalized message in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

Information regarding the availability to receive a personalized advertiser message is physically placed in a location of strategic interest (e.g., a billboard, sign, placard, etc. with such information is placed adjacent to a desired consumer product in a retail location). Based on the information, a consumer requests the personalized message (e.g., via telephone call, email, or text message). The personalized message (which may contain consumer product information, discounts, etc. that has been specifically tailored/personalized to the user) is then received by the consumer near-instantaneously.

### Network Environment

Embodiment of the invention may be implemented on a network that connects thin client devices to other thin client devices or server devices. As used herein, thin client devices include cellular devices, cellular phones, personal digital assistants, music players (e.g., IPOD™, IPOD TOUCH™, Blackberry™), WinCE™ devices, or any small handheld type devices with a limited or full processing capabilities. Traditionally, such hand-held devices are limited in their processing and memory capabilities. However, this invention is not intended to be limited to such devices and is intended to include any small or handheld devices regardless of their processing capabilities or memory capacity. The description herein is also directed towards the exemplary cellular/wireless phone based environment. However, embodiments may also be implemented in any type of network or system capable of transmitting content and advertisements.

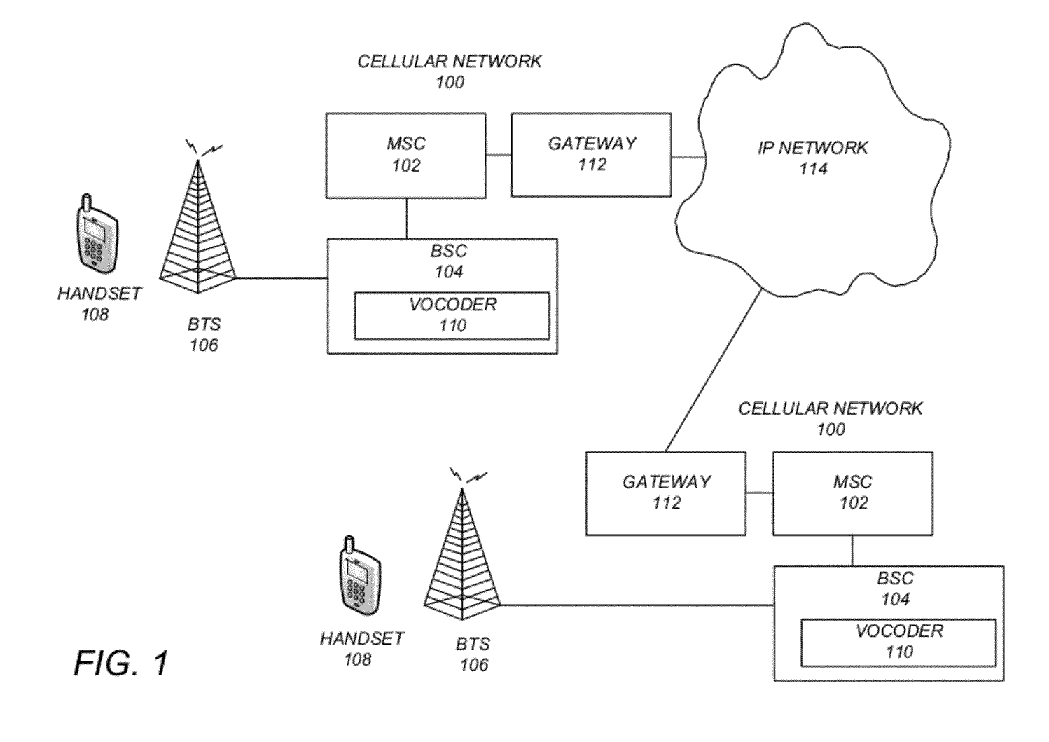

FIG. 1 illustrates an exemplary network configuration that could be used to provide inter-network communications. This exemplary network configuration may be comprised of interconnected cellular networks (e.g., AMPS [advanced mobile phone system], GSM [global system for mobile communications], TDMA [time division multiple access], or CDMA [code division multiple access] cellular networks), public land mobile networks (PLMNs), public switched telephone networks (PSTNs), and Internet Protocol (IP) networks.

In the example of FIG. 1, a cellular network 100 includes at least one MSC (Mobile Switching Center) 102, at least one BSC (Base Station Controller) 104, and at least one BTS (Base Transceiver Station) 106 for communicating with one or more handsets 108 or other transceivers. The BSC 104 includes a vocoder 110 for encoding and decoding voice signals received from and sent to the handset 108. The MSCs 102 of two different cellular networks 100 each connects to a separate Gateway 112 that interfaces into an IP network 114. In this manner, the cellular networks 100 communicate across the IP network 114. Also, in one embodiment, the cellular networks 100 themselves may be IP networks.

Video applications may be utilized on any thin client devices including handsets 108. Further, video may be streamed to such thin client devices using the cellular network 100 or other IP network. Commercials and/or advertisements may be streamed at the beginning, middle, or end of such a video stream (e.g., similar to traditional television advertisements). Internet access may also be provided to thin client devices (e.g., via cellular network 100 to handsets 108, or via a WiFi or cabled connection). Such an Internet connection may be utilized to deliver advertisements/advertisement impressions/commercials to thin client devices and/or standard client devices such as a computer.

Further, advertisements that are displayed on thin client devices may be ads within/or enabled by various applications on/for the browser on the thin client device. In addition, similar to the broadcast programming environment, the advertisement may not be limited to an audio/video form but may be displayed in a frame around an application and may consist of text, audio, video, static images, etc.

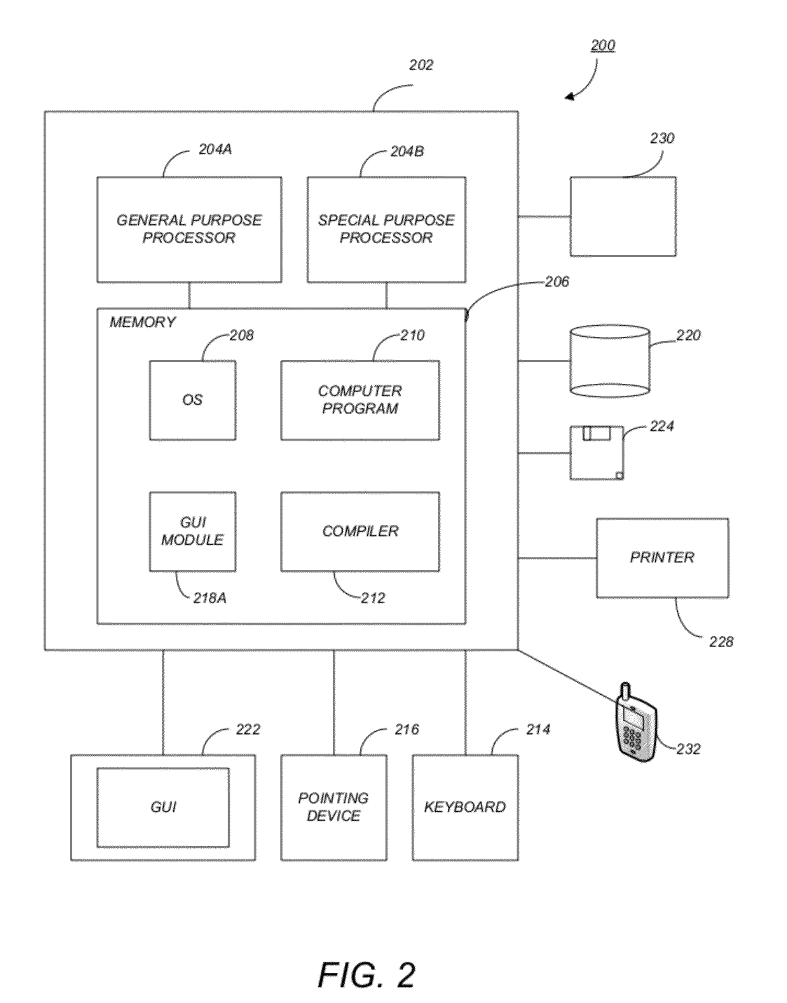

FIG. 2 is an exemplary hardware and software environment 200 used to implement one or more embodiments of the invention. The hardware and software environment may define a thin client device 108 of FIG. 1 or a standard device such as a computer 202 and may include peripherals. As used herein, the thin client device 108 and computer 202 may have similar functionality and capabilities. Computer 202 may be a user/client computer, server computer, thin client device, or may be a database computer. The computer 202 comprises a general purpose hardware processor 204A and/or a special purpose hardware processor 204B (hereinafter alternatively collectively referred to as processor 204) and a memory 206, such as random access memory (RAM). The computer 202 may be coupled to integrated with other devices, including input/output (I/O) devices such as a keyboard 214, a cursor control device 216 (e.g., a mouse, a pointing device, pen and tablet, touch screen, multi-touch device, etc.) and a printer 228. In one or more embodiments, computer 202 may be coupled to or may comprise a thin client device 108 such as a portable or media viewing/listening device 232 (e.g., an MP3 player, iPod™, Nook™, portable digital video player, cellular device, personal digital assistant, etc.).

In one embodiment, the computer 202 operates by the general purpose processor 204A performing instructions defined by the computer program 210 under control of an operating system 208. The computer program 210 and/or the operating system 208 may be stored in the memory 206 and may interface with the user and/or other devices to accept input and commands and, based on such input and commands and the instructions defined by the computer program 210 and operating system 208 to provide output and results.

Output/results may be presented on the display 222 or provided to another device for presentation or further processing or action. In one embodiment, the display 222 comprises a liquid crystal display (LCD) having a plurality of separately addressable liquid crystals. Alternatively, the display 222 may comprise a light emitting diode (LED) display having clusters of red, green and blue diodes driven together to form full-color pixels. Each liquid crystal or pixel of the display 222 changes to an opaque or translucent state to form a part of the image on the display in response to the data or information generated by the processor 204 from the application of the instructions of the computer program 210 and/or operating system 208 to the input and commands. The image may be provided through a graphical user interface (GUI) module 218A. Although the GUI module 218A is depicted as a separate module, the instructions performing the GUI functions can be resident or distributed in the operating system 208, the computer program 210, or implemented with special purpose memory and processors.

In one or more embodiments, the display 222 is integrated with/into the computer 202 and comprises a multi-touch device having a touch sensing surface (e.g., track pod or touch screen) with the ability to recognize the presence of two or more points of contact with the surface. Examples of a multi-touch devices include mobile devices (e.g., iPhone™, Nexus S™, Droid™ devices, etc.), tablet computers (e.g., iPad™, HP Touchpad™), portable/handheld game/music/video player/console devices (e.g., iPod Touch™, MP3 players, Nintendo 3DS™, PlayStation Portable™, etc.), touch tables, and walls (e.g., where an image is projected through acrylic and/or glass, and the image is then backlit with LEDs).

Some or all of the operations performed by the computer 202 according to the computer program 210 instructions may be implemented in a special purpose processor 204B. In this embodiment, some or all of the computer program 210 instructions may be implemented via firmware instructions stored in a read only memory (ROM), a programmable read only memory (PROM) or flash memory within the special purpose processor 204B or in memory 206. The special purpose processor 204B may also be hardwired through circuit design to perform some or all of the operations to implement the present invention. Further, the special purpose processor 204B may be a hybrid processor, which includes dedicated circuitry for performing a subset of functions, and other circuits for performing more general functions such as responding to computer program instructions. In one embodiment, the special purpose processor is an application specific integrated circuit (ASIC).

The computer 202 may also implement a compiler 212 which allows an application program 210 written in a programming language such as COBOL, Pascal, C++, FORTRAN, or other language to be translated into processor 204 readable code. Alternatively, the compiler 212 may be an interpreter that executes instructions/source code directly, translates source code into an intermediate representation that is executed, or that executes stored precompiled code. Such source code may be written in a variety of programming languages such as Java™, Perl™, Basic™, etc. After completion, the application or computer program 210 accesses and manipulates data accepted from I/O devices and stored in the memory 206 of the computer 202 using the relationships and logic that was generated using the compiler 212.

The computer 202 also optionally comprises an external communication device such as a modem, satellite link, Ethernet card, or other device for accepting input from and providing output to other computers 202.

In one embodiment, instructions implementing the operating system 208, the computer program 210, and the compiler 212 are tangibly embodied in a computer-readable medium, e.g., data storage device 220, which could include one or more non-transient fixed or removable data storage devices, such as a zip drive, floppy disc drive 224, hard drive, CD-ROM drive, tape drive, etc. Further, the operating system 208 and the computer program 210 are comprised of computer program instructions which, when accessed, read and executed by the computer 202, causes the computer 202 to perform the steps necessary to implement and/or use the present invention or to load the program of instructions into a memory, thus creating a special purpose data structure causing the computer to operate as a specially programmed computer executing the method steps described herein. Computer program 210 and/or operating instructions may also be tangibly embodied in memory 206 and/or data communications devices 230, thereby making a computer program product or article of manufacture according to the invention. As such, the terms “article of manufacture,” “program storage device” and “computer program product” as used herein are intended to encompass a computer program accessible from any computer readable device or media.

Of course, those skilled in the art will recognize that any combination of the above components, or any number of different components, peripherals, and other devices, may be used with the computer 202.

Generally, the components of FIGS. 1 and 2 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the term “user computer”, “client computer”, “thin client”, and/or “server computer” is referred to herein, it is understood that such computers 202 and may include thin client devices with limited or full processing capabilities, portable devices such as cell phones, notebook computers, pocket computers, multi-touch devices, and/or any other device with suitable processing, communication, and input/output capability.

Of course, those skilled in the art will recognize that any combination of the above components, or any number of different components, peripherals, and other devices, may be used with computers 202 and thin client device 108.

### Logical Flow Overview

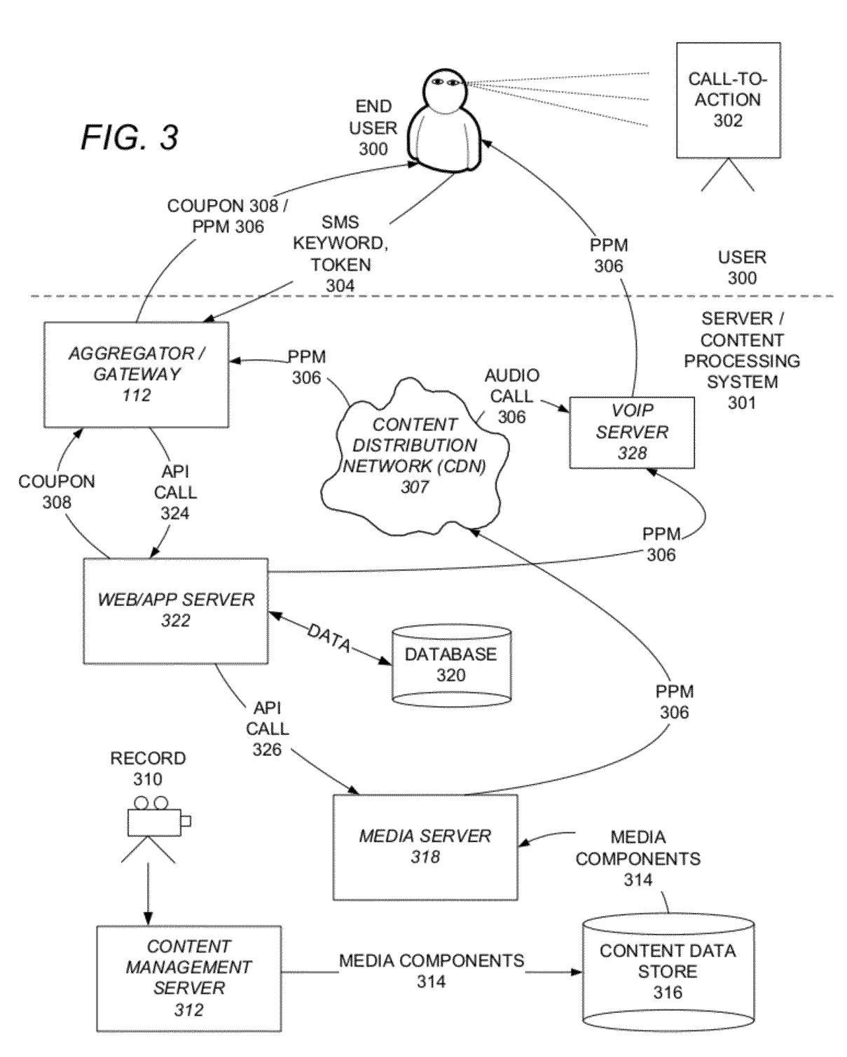

Embodiments of the invention are implemented using thin client devices 108, computers 202, and other components as described herein. FIG. 3 is a data flow diagram utilized to personalize advertising to a user in accordance with one or more embodiments of the invention. FIG. 3 is divided into a user 300 perspective and a server/processing/content processing system 301 perspective.

Customer/User Perspective

The end user 300 is at a geographic location proximate to a location of interest. A consumer product “call-to-action” 302 is placed in the location of interest. The call-to-action 302 is independent or included in, a sign, placard, billboard, etc. and offers the consumer (e.g., end user 300) a personalized advertiser message. The call-to-action 302 includes a specific numeral or alphabetic code identifying the subject consumer product and the location of the call-to-action display (e.g., retail store, movie theater, etc.). Such a location may also include a geographic designation (e.g., a retail store or movie theater in Los Angeles, Calif.).

The call-to-action 302 solicits consumers 300 to send this code and the consumer's name by means of telephone call, email, or text message (e.g., short-message-service [SMS]) 304, in order to receive the personalized promotional message 306 (e.g., an audio or audiovisual message 306) by means of an audio call (e.g., telephone), email, social media message, text message, or multimedia message (MMS) (e.g., audio or video MMS).

Once generated, the personalized message 306 is received by the consumer 300 near-instantaneously. The personalized message 306 identifies the consumer 300 by name, in the subject location, and provides consumer product information, discounts, or other consumer product messages related to the availability of the consumer product in/at the subject location. Further details regarding the elements and interaction of the dataflow of FIG. 3 are discussed below.

An example of the data flow may be illustrated via a department store in the Union Square neighborhood of New York City. Such a department store may have a call-to-action 302 in the form of a retail display in the cosmetics section. The retail display may feature an image of a celebrity spokesperson using a particular consumer product with a written message “Text 351 and your first name to 343434”. The customer 300 walking by the display views the cal-to-action 302, and follows the instructions/call-to-action 302 (by sending the SMS, keyword, or token 304). Within a few seconds after sending the text, the customer's mobile phone (that was used to send the original text) would ring and the user 300 may hear a message such as “Hi Annie, this is [celebrity say their name] and I see that you are in the Bloomingdales in Union Square. I wanted to tell you how much I love using [the subject consumer product]. In a few seconds, I'm going to text you a coupon code that you can use at the counter right now to get a 10% discount.” Within a few seconds, the customer's phone would receive the said SMS text with a coupon code 308.

Server/Content Processing System Perspective

The processing below the dashed line of FIG. 3 illustrates the processing performed by the back-end/server/content processing system 301.

The process starts with the writing and recordation of the content to be sent to the consumer user 300. A script with dialog for the promotional message 306 to be delivered is written/obtained. A celebrity or chosen spokesperson is then engaged for in-studio recording of the script. In the recording session, and as per the written script, a list of variable names (e.g., Mark, Jason, Arthur, Andrea, Erin, Annie, etc.), locations (e.g., New York City, Bloomingdales Department Store, Central Park, etc.), or other variable information are recorded 310. Such variables may be chosen by the user 300 (e.g., their name) and/or based upon a location, consumer product specification, or other similar customizable option designated by numerical, alphabetical, or combination codes (see further details below). The recordings 310 of the script and the variables are digitized (e.g., by a content management server 312) into uncompressed sound files (i.e., media components 314) that are catalogued in a database/content data store 316 used by the content processing system/content management server 301.

Various consumer product/location codes are established where each number or letter in the code would be recognized by the content processing system 301 and used to pull the necessary media clips/digital files from a database association with a geographic location (e.g., New York in the above example could be identified by the number 3), a retail location (e.g., the department store in the above example could be identified by the number 5), and/or the consumer product (e.g., the cosmetic product in the above example could be identified by the number 1).

When the consumer 300 transmits the consumer product/location code and their name 304 to a designated telephone number, email address, or text-based “short code”, the content processing system 301 (e.g., the media server 318) retrieves the aforementioned digital media files (e.g., from the content data store 316) and concatenates the files into one, single digital file. Such concatenation may be performed using a variety of methods including the open-source Linux™ “cat” command. The single digital file comprises a personalized promotional message 306 and may be stored on a Content Distribution/Delivery Network (CDN) 307. Such a CDN 307 is a system of computers containing copies of data placed at various nodes of a network. Thus, an optimal node of the CDN 307 may be selected to retrieve/transmit the personalized promotional message 306 to the user 300.

Once created, the single digital file/personalized promotional message 306 is wirelessly streamed or downloaded to the mobile device from which the consumer 300 sent the original message as a personalized telephone call, SMS or MMS message, email or social media message, via the aggregator/gateway 112 (e.g., for email/social messages and audio/or video MMS) or via voice over internet protocol [VOIP] server 328 (e.g., for audio calls). In yet another embodiment, the user 300 receives (e.g., in the user's cellular device) a link or other information about where to retrieve the message (e.g., a uniform resource locator [URL] to a website, CDN 307, or other storage location). In such an embodiment, the user 300 may take action to retrieve the personalized message 306.

The single concatenated digital file 306 received by the consumer 300 identifies the consumer 300 by name and “plays” a seamless message with no audio or audiovisual indication that such a message was compiled from separate messages by the content processing system 301 (or media server 318).

### Detailed Technical Description of Content Processing System 301

Further details regarding the interaction with the user 300 and the content processing system 301 are described herein while referencing FIGS. 3, 4, and 5.

Users 300 see a call-to-action 302 that includes the text “Text KEYWORD and TOKEN to SHORTCODE” (e.g., “Text 352 and NAME to 343434”). The TOKEN denotes the user's name and is a component position in the script product (e.g., position 1). KEYWORD denotes other personalized attributes for the message that are associated with the KEYWORD. For example, 352 may denote a Walgreens™ retail store in New York. SHORTCODE denotes the phone number, email, or other alphanumeric designation of where to send/transmit the KEYWORD and TOKEN.

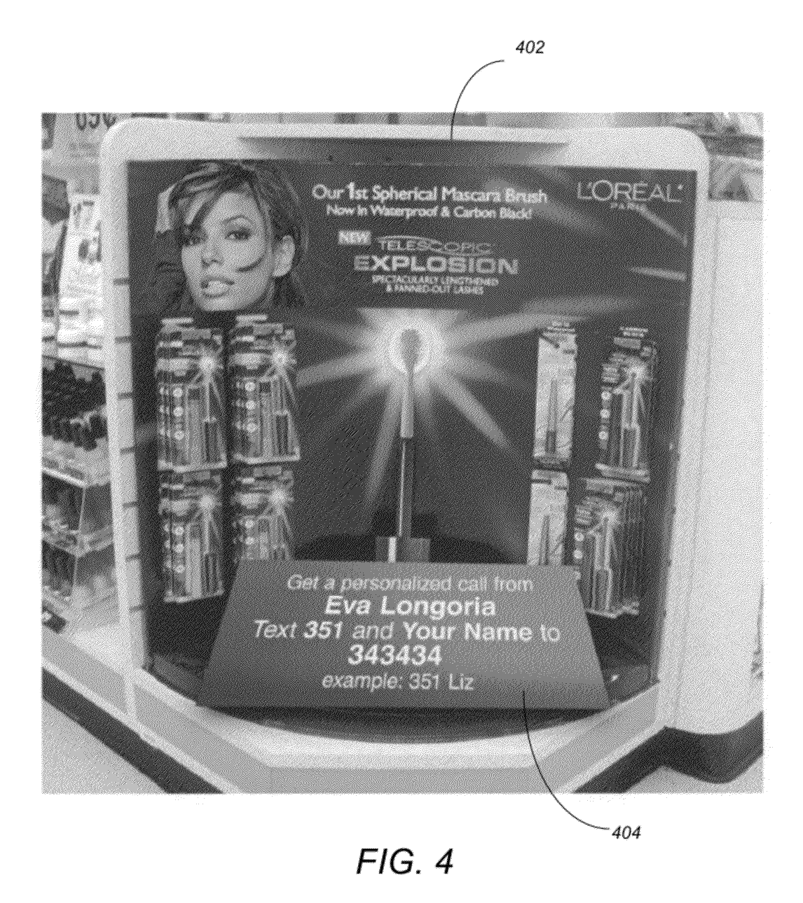

FIG. 4 illustrates an exemplary call-to-action 302 in accordance with one or more embodiments of the invention. In FIG. 4, the advertisement display 402 for L'Oreal™ is placed in a retail location. Within the advertisement display 402, a sign 404 contains the following text:
Get a personalized call from
Eva Longoria
Text 351 and Your Name to
343434
example: 351 Liz

As used in the call-to-action 404 of FIG. 4, the KEYWORD is “351”, the TOKEN is “Your Name”, and the SHORTCODE is “343434”.

The SMS with the KEYWORD and TOKEN are received by an SMS Gateway 112 (e.g., described above with respect to FIG. 1). The gateway 112 may also be an email or social messaging gateway. Such an email gateway interfaces (via API calls) with one or more email delivery mechanisms (e.g., providers). Similarly, a social messaging gateway interfaces (via API calls) with one or more social network delivery mechanisms (e.g., providers). Alternatively, an SMS/MMS aggregator may be used (e.g., the OpenMarket™ SMS/MMS aggregator). An SMS/MMS aggregator lack direct access into the SS7 protocol (the protocol where SMS messages are exchanged) and have no visibility and control over the message delivery. Instead, an aggregator is used to transmit and deliver messages to an operator's short message service center (SMS-C) (also known as “local termination model”) which is responsible for delivery to/from a subscriber's handset.

Embodiments of the invention integrate an application 322 with the aggregator and/or gateway to enable a connection with most or all of the major mobile carriers (as described in FIG. 1). The user input 304 is passed via the gateway 112 to the web/application server 322 (e.g., in an application programming interface [API] call 324).

The application server 322 parses out the user inputs of KEYWORD and TOKEN. Based on the KEYWORD, the application 322 selects the specific product identification (script) and passes (e.g., via API call 326) the TOKEN as a variable of that script product. As used herein, a script product refers to a collection of digital media clips/components 314 that can be combined to form personalized digital messages 306 that are transmitted electronically to end users 300. A script product consists of two or more positions. To create a personalized message 306, at least one position in the script product must be a variable position. A position is a logical section of a script product's message (e.g., the message recipient's name). Each position comprises one or more media clips/components 314. A position that comprises a single media clip/component 314 is considered a static position (i.e., it is the same for every personalized instance of the product). A position that comprises more than one media clip/component 314 is considered a variable position (i.e., it can differ from one personalized instance of the product to another).

In the example described herein, there is one variable position (identified by TOKEN—the user's 302 name in the example) in the script product. The other position is static and is based on the KEYWORD. The parameters are passed from the application server 322 to the media server 318 for content processing.

The web/application server 322 and media server 318 both run a software application that may be written in a variety of programming languages/framework. In an exemplary embodiments, the Ruby on Rails™ open source web application framework for the Ruby™ programming language may be used (referred to herein as the “Rails Application”). On the web app/server 322, the Rails Application takes user 300 input and passes it to the media server 318. On the media server 318, the Rails Application uses inputs (e.g., in API call 326) provided from the web/app server 322 to concatenate and transcode media to produce a personalized processed media file/personalized message 306. The Rails Application is a three-tiered software architecture comprised of data (model), presentation (view), and business logic (controller). The view is the user interface that facilitates variable selection. The controller takes user input and computes it to produce output. The model interfaces with the database 316 and 320.

Thus, the web app/server 322 contains code for processing and user interactions and interfaces with the media server 318 for content processing. The media server 318 contains code for both audio and video asset generation. An exemplary API call 326 received by the media server 318 from the web/app server 322 may provide: “POST/audio/generate” or “POST/video/generate”. Such a command would make a final asset/personalized promotional message 306 from clips specified in the post parameters (join_{—}1=>unique_clip_id, join_{—}2=>unique_clip_id . . . join_{—}10). The final asset/personalized promotional message 306 may then be pushed to storage such as a CDN 307 (e.g., local or “cloud-based” storage such as Amazon™ Simple Storage Service [S3]). If pushed to a storage service, a unique identifier (e.g., an S3 string) may be passed back to the application server 322. The final clip/personalized promotional message 306 may then be delivered to the user 300 via the method(s) of delivery configured for the particular script product in the content management server 312 (e.g., outbound call, email, etc.). For example, the personalized promotional message 306 in the form of an audio or audio/video message may be delivered using a voice over IP server 328 across a network. Similarly, a coupon or discount 308 may be transmitted via the aggregator/gateway 112.

To enable the above described features, a content management system (CMS) interface may be executed by the web/app server 322 that allows an administrator to upload the media component clips 314 and designate them by join position in a script (e.g., 1, 2, 3). Each script is set-up as a script product in the CMS application. Some positions only contain one media component 314. Such positions are static positions. When a user 300 selects variables for variable script positions, on the web/app server 322, the query string is passed to the media server 318. As described above, the media server 318 concatenates the selected media component clips 314 and transcodes them to appropriate formats for the device(s) specified in the delivery method. In one or more embodiments, a print method in the Rails Application may be used to concatenate the clips/components 314 including looking through the media components 314, slipping the watermark clip, and printing the completed clip to a stored object. Exemplary code for such a print method provides:

if (product.audio_watermark.present? and

product.audio_watermark.id == f.to_i) or
(product.audio_bed.present? and
product.audio_bed.id == f.to_i) then
nil

else

tf.print(AudioClipRedis.grap(f).stored_object)

As can be seen from the above code, if a watermark exists in the audio, the component is not added to the completed/concatenated clip. However, if no water mark is present, the clip is printed to an object (containing the concatenated components 314) and stored. After concatenation, the digital file is transcoded. A variety of encoders may be used for audio and/or video encoding. For example, a SoX™ audio editor (Sound eXchange audio editor) may be used for audio encoding and FFMPEG may be used for video encoding. However, the watermarking aspect described herein may only apply to premium content and may not be added to promotional point-of-sale message script products such as the personalized promotional message 306 described herein.

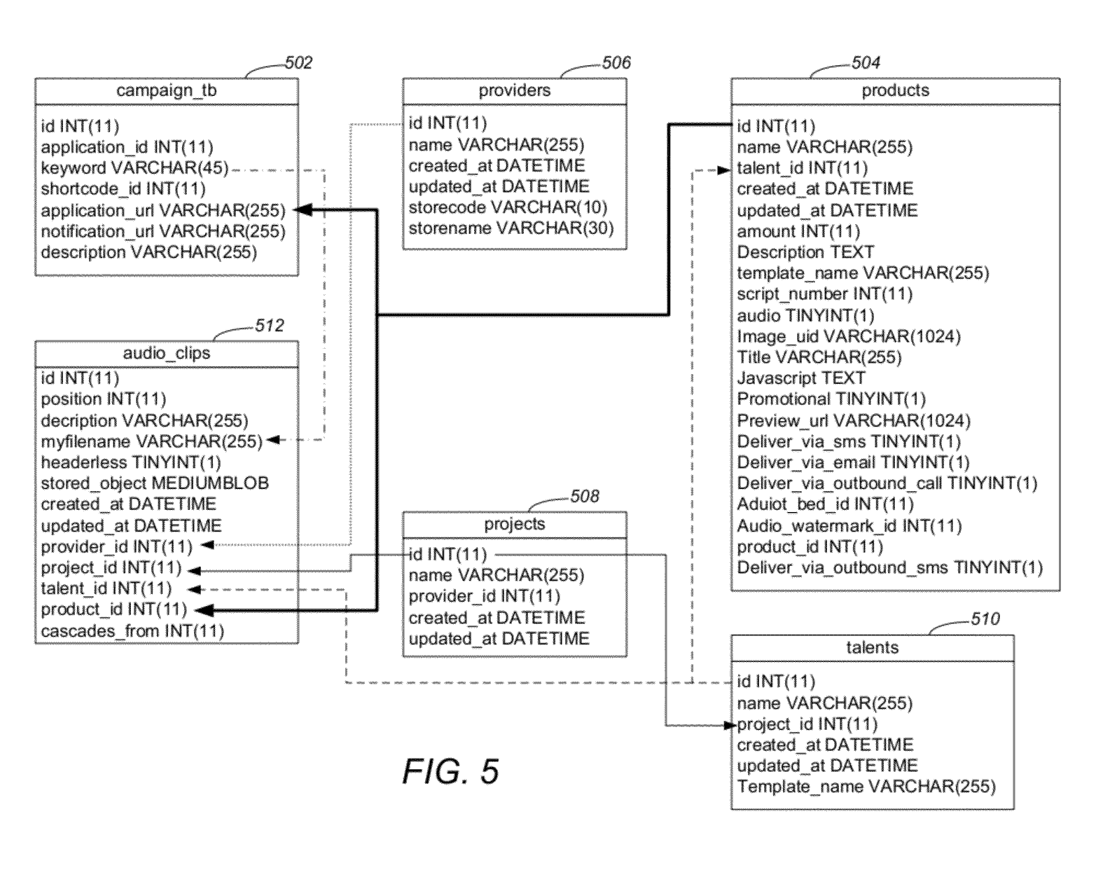

FIG. 5 illustrates a portion of the database schema used to store media components 314 and concatenated clips in a database 316 or 320 in accordance with one or more embodiments of the invention. A relational database may be used to store such tables and key-value pairs. An exemplary relational database is the MySQL™ relational database. However, the invention is not intended to be limited to a particular relational/non-relational database. In this regard, content data store 316 may be used to store the actual media components 314, while database 320 contains the metadata and database information relating to the media components and the personalized promotional messages 306.

The campaign table 502 stores data from the SMS gateway 112 including the KEYWORD and maps an application URL to a product ID (i.e., from the products table 504).

The products table 504 stores product metadata relating to the script product including the number of positions in the script.

The providers table 506 stores product metadata relating to a content provider who provided the component media files 314.

The projects table 508 stores product metadata relating to a project folder containing the component media files 314.

The talents table 510 stores product metadata relating to the talent who recorded the component media clips 314.

The audio clips table 512 stores data including the concatenated media clip (myfilename) and product metadata.

The various lines indicate the relations between the various keys in each table.

### Logical Flow

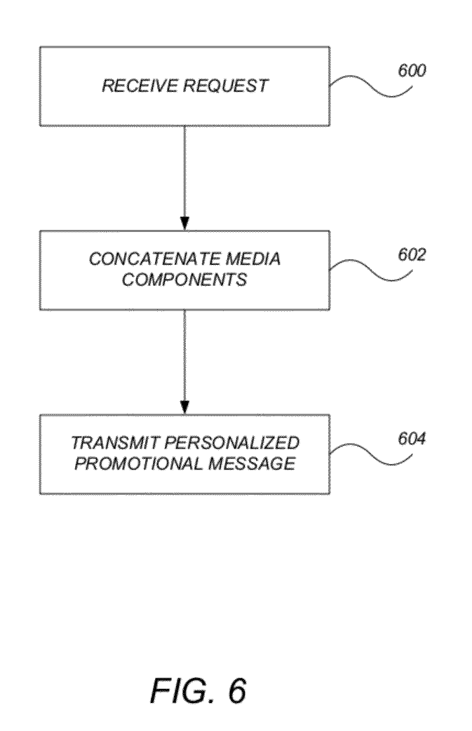

FIG. 6 illustrates the logical flow for creating and delivering a point-of-sale personalized message in accordance with one or more embodiments of the invention.

At step 600, a request is received for the personalized promotional message. Such a request may be received via a short message service gateway or aggregator. Further, the request may be received in response to a call-to-action that is displayed proximate to a consumer product that is promoted via the personalized promotional message. As described above, the request may be received by an application server that parses the request and passes information from the parsed request to a media server.

The request includes a keyword that denotes one or more personalized attributes and a token that denotes a name of a consumer and is a component position in a script product. The keyword may be an alphanumeric code that identifies the consumer product to be promoted and a location of the call-to-action.

At step 602, based on the request (e.g., information in the request), media components are concatenated to produce the personalized promotional message (e.g., an audio or audio-video personalized message). As described above, the media server may perform the concatenation operation once the parsed request is received from the application server. The personalized message may identify the consumer by name and provide product information for the consumer product at the location. Further, the personalized message may also include a coupon or discount to purchase the consumer product proximate to the location. Such coupon/discount may be sent as part of the personalized message or may be delivered separately to the user/consumer.

Step 602 may also include the use of a relational database where the media components are stored, catalogued and indexed based on the script product (e.g., as described above with respect to the database schema of FIG. 5).

At step 604, the personalized promotional message is transmitted (e.g., via the gateway/aggregator/VOIP server) for receipt by the consumer. Such a transmission may occur near instantaneously (e.g., within ten [10] seconds) of receipt of the request. Accordingly, the application and media servers are configured to dynamically create the single concatenated message and deliver/transmit that message to the user at the location of the call-to-action.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, standalone personal computer, cellular device, or tablet computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for providing a personalized promotional message, comprising:
(a) receiving a request for the personalized promotional message, wherein the request comprises:
(i) a keyword that denotes one or more personalized attributes; and
(ii) a token that denotes a name of a consumer and is a component position in a script product;
(b) based on the request, concatenating media components to produce the personalized promotional message;
(c) transmitting the personalized promotional message for receipt by the consumer.

2. The computer-implemented method of claim 1, wherein the request is received via a short message service gateway or aggregator.

3. The computer-implemented method of claim 1, wherein the request is received in response to a call-to-action that is displayed proximate to a consumer product that is promoted via the personalized promotional message.

4. The computer-implemented method of claim 3, wherein the keyword comprises an alphanumeric code that identifies:
the consumer product to be promoted in the personalized promotional message; and
a location of the call-to-action.

5. The computer-implemented method of claim 4, wherein:
the personalized promotional message identifies the consumer by name; and
provides product information for the consumer product at the location.

6. The computer-implemented method of claim 4, wherein the personalized promotional message comprises a coupon or discount to purchase the consumer product proximate to the location.

7. The computer-implemented method of claim 1, wherein the personalized promotional message is transmitted within ten (10) seconds of receipt of the request.

8. The computer-implemented method of claim 1, wherein:
the request is received by an application server;
the application server parses the request and passes information from the parsed request to a media server;
the media server performs the concatenating;

9. The computer-implemented method of claim 1, wherein the personalized promotional message comprises an audio or audio-visual personalized message.

10. The computer-implemented method of claim 1, wherein:
the media components are catalogued in a relational database; and
the media components are indexed in the relational database based on the script product.

11. A system for providing a personalized promotional message comprising:
(a) an application server computer;
(b) a server application executing on the application server computer wherein the server application is configured to:
(i) receive a request for the personalized promotional message, wherein the request comprises:
(1) a keyword that denotes one or more personalized attributes; and
(2) a token that denotes a name of a consumer and is a component position in a script product;
(ii) call a media application for further processing of the request;
(c) a media server computer;
(d) the media application executing on the media server computer, wherein the media application is configured to:
(i) receive the call from the server application; and
(ii) concatenate, based on the request, media components to produce the personalized promotional message; and
wherein the server application is further configured to transmit the personalized promotional message for receipt by the consumer.

12. The system of claim 11, wherein the request is received via a short message service gateway or aggregator.

13. The system of claim 11, wherein the request is received in response to a call-to-action that is displayed proximate to a consumer product that is promoted via the personalized promotional message.

14. The system of claim 13, wherein the keyword comprises an alphanumeric code that identifies:
the consumer product to be promoted in the personalized promotional message; and
a location of the call-to-action.

15. The system of claim 14, wherein:
the personalized promotional message identifies the consumer by name; and
provides product information for the consumer product at the location.

16. The system of claim 14, wherein the personalized promotional message comprises a coupon or discount to purchase the consumer product proximate to the location.

17. The system of claim 11, wherein the personalized promotional message is transmitted within ten (10) seconds of receipt of the request.

18. The system of claim 11, wherein the personalized promotional message comprises an audio or audio-visual personalized message.

19. The system of claim 11, further comprising a relational database configured to:
catalogue the media components; and
index the media components based on the script product.
